(19) United States
(12) Patent Application Publication
(10) Pub. No.: US 2011/0065026 A1
(43) Pub. Date: Mar. 17, 2011

(54) FUEL CELL WITH CATALYST LAYER SUPPORTED ON FLOW FIELD PLATE

(75) Inventor: Alireza Pezhman Shirvanian, Ann Arbor, MI (US)

(73) Assignee: FORD MOTOR COMPANY, Dearborn, MI (US)

(21) Appl. No.: 12/561,522

(22) Filed: Sep. 17, 2009

(51) Int. Cl. H01M 2/00

(52) U.S. Cl. 429/530; 429/532

(57) ABSTRACT

A fuel cell includes a plate system including a porous media having a surface that defines a plurality of channels configured to distribute gas throughout the plate system, and a catalyst layer in contact with the porous media. The porous media is configured to permit the gas to move from the channels, through the porous media, and to the catalyst layer.

### BACKGROUND

FIG. 1 illustrates a portion of a conventional fuel cell 10 in cross-section. The fuel cell 10 includes a non-porous plate 12, a gas diffusion layer 14 in contact with the plate 12, a catalyst layer 16 in contact with the gas diffusion layer 14 (together forming an anode), and a proton exchange membrane 18 in contact with the catalyst layer 16.

Channels 20 formed in the plate 12 are configured to direct gas, such as hydrogen, to the gas diffusion layer 14. The gas diffuses through the gas diffusion layer (as indicated by arrow) to the catalyst layer 16. The catalyst layer 16 promotes separation of the hydrogen into protons and electrons. The protons migrate through the membrane 18. The electrons travel through an external circuit (not shown).

Oxygen may flow to a cathode portion (not shown) of the fuel cell 10. The protons that migrate through the membrane 18 combine with the oxygen and electrons returning from the external circuit to form water and heat.

FIG. 2 illustrates a portion of another conventional fuel cell 22 in cross-section. The fuel cell 22 includes a corrugated, non-porous plate 24 with opposing surfaces 26, 28, a contact plate 30 in contact with portions of the surface 26, a gas diffusion layer 32 in contact with portions of the surface 28, a catalyst layer 34 in contact with the gas diffusion layer 32, and a proton exchange membrane 36 in contact with the catalyst layer 34.

Portions of the surface 26 and plate 30 define channels 33 configured to direct coolant through the fuel cell 22. Portions of the surface 28 and the gas diffusion layer 32 define channels 35 configured to direct gas to the gas diffusion layer 32. The gas diffuses through the gas diffusion layer 32 (as indicated by arrow) to the catalyst layer 34.

### SUMMARY

A fuel cell includes a plate having a flow field formed therein, a catalyst layer in contact with the plate, and a proton exchange membrane in contact with the catalyst layer. The flow field is configured to distribute gas throughout the plate. The plate is configured to permit the gas to at least one of convect and diffuse from the flow field, through the plate, and to the catalyst layer.

A fuel cell includes a plate at least partially defining a flow field configured to distribute gas throughout the plate, a porous matrix deposited on the plate, a catalyst layer in contact with the porous matrix, and a proton exchange membrane in contact with the catalyst layer. The porous matrix is configured to permit the gas to convect from the flow field, through the porous matrix, and to the catalyst layer.

A fuel cell includes a plate system including a porous media having a surface that defines a plurality of channels configured to distribute gas throughout the plate system, and a catalyst layer in contact with the porous media. The porous media is configured to permit the gas to move from the channels, through the porous media, and to the catalyst layer.

While example embodiments in accordance with the invention are illustrated and disclosed, such disclosure should not be construed to limit the invention. It is anticipated that various modifications and alternative designs may be made without departing from the scope of the invention.

### BRIEF DESCRIPTION OF THE DRAWINGS

FIG. 1 is an end view, in cross-section, of a portion of a conventional fuel cell.

FIG. 2 is an end view, in cross-section, of a portion of another conventional fuel cell.

FIG. 3 is an end view, in cross-section, of a portion of an embodiment of a fuel cell.

FIG. 4 is an end view, in cross-section, of a portion of another embodiment of a fuel cell.

FIG. 5 is an end view, in cross-section, of a portion of yet another embodiment of a fuel cell.

FIG. 6 is a plot of example polarization curves for cathodes with and without gas diffusion layers based on geometric land area.

FIG. 7 is a plot of example polarization curves for cathodes with and without gas diffusion layers based on actual land area.

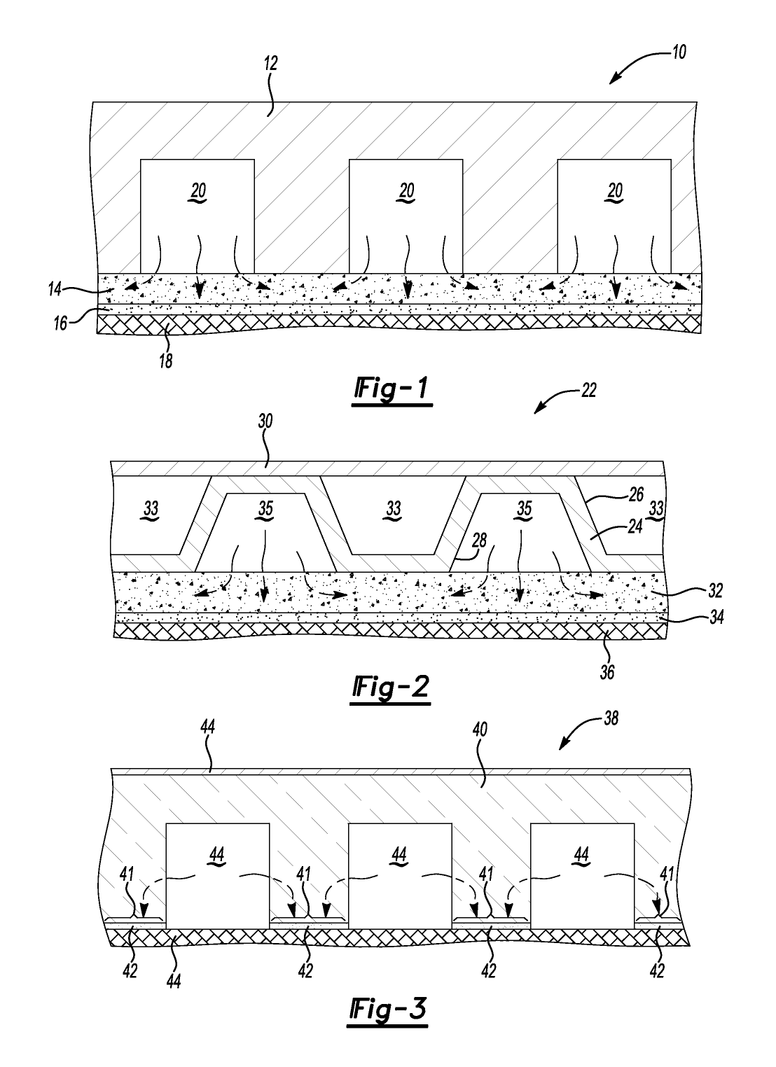

### DETAILED DESCRIPTION

In certain proton exchange membrane fuel cells, anode and cathode gas diffusion layers allow hydrogen and air/oxygen respectively to reach catalyst layers within electrodes. Electrons and heat conduct through the gas diffusion layers, which form a link between the catalyst layers and cooling plates/collector plates. Water may also be removed via gas diffusion layers.

Gas diffusion layers (which are typically made from carbon fibers or cloth) may introduce significant Ohmic resistance, have low heat conductivity, and be subjected to mechanical stresses. Ohmic resistance may contribute to electrical losses within the fuel cell circuit. Low heat conductivity may make heat management difficult within the fuel cell. Mechanical stresses may change properties, such as porosity, of the gas diffusion layers. Additionally, reactants typically have to diffuse under the gas diffusion layers to reach active areas under landing/current collectors. This may limit channel and landing/current collector width.

Certain embodiments of fuel cells described herein lack gas diffusion layers. Instead, flow fields formed in porous materials support catalyst layers and/or manage water. Several benefits may result: (i) improved electrical and heat conductivity within the fuel cell—porous metals/graphite/etc. may be capable of conducting electricity and heat better than carbon based gas diffusion layers, thereby reducing Ohmic resistances and improving heat management; (ii) shortened diffusion paths of protons to catalyst layers—by removing gas diffusion layers, the path that protons traverse to reach active areas may be reduced, therefore, reducing mass transport limitations due to the flow of protons/ions; (iii) increased structural stability of the cell—having a rigid structure and high resistance to tensile and compressive stresses, porous electrodes could be made from metals or other materials to maintain their porous structure regardless of mechanical stresses they are subjected to during installation and operation; (iv) improved distribution of reactants and catalyst utilization—because reactants may no longer need to diffuse through gas diffusion layers to reach active areas under lands, landing areas may be made larger and thus can support more catalyst; and (v) reduced manufacturing cost and complexity—eliminating gas diffusion layers reduces the number of parts to be purchased and assembled.

Referring now to FIG. 3, an embodiment of a fuel cell 38 includes a porous plate 40 (graphite, porous carbon, porous metal, etc.) having landing areas 41, a catalyst layer 42 in contact with the landing areas 41, and a proton exchange membrane 44 in contact with the catalyst layer 42. A non-porous cover, layer, coating, etc. 44 (such as metallic plates, conductive glue, etc.) may be applied to outer surfaces of the plate 40.

Channels 44 formed in the plate 40 (defining a flow field) are configured to direct gas, such as hydrogen or air, through the plate 40. In the embodiment of FIG. 3, the channels 44 are rectangular in cross-section and form a serpentine passageway through the plate 40. In other embodiments, the channels 44 may take any suitable shape in cross-section and may form an interdigitated, noninterdigitated, fractal, straight-flow, etc. passageway through the plate 40.

The porosity of the plate 40 is such that the gas in the channels 44 convects and/or diffuses through the plate to the catalyst layer 42 (as indicated by arrow) and also between the channels 44. (As known in the art, pressure gradients drive convection whereas concentration gradients drive diffusion.) The porosity of the plate 40 may range from 0.01 to 0.99 and need not be uniform. For example, the porosity of the plate 40 near the landing areas 41 may be less than elsewhere. The tortuosity of the plate 40 may be at least 1. Optimum plate porosity (distribution) and tortuosity for a given fuel cell design may be determined based on testing, simulation, etc.

Because the plate 40 (instead of a gas diffusion layer) distributes reactants to the catalyst layer 42, channels having relatively large dimensions are not necessary. As a result, smaller channels and larger landing/current collector areas may be achieved. For example, landing areas may be increased by a factor of 2 (or larger) in some configurations. Additionally, these smaller channels may remain free from flooding as the porous plate 40 may absorb any water droplets that form.

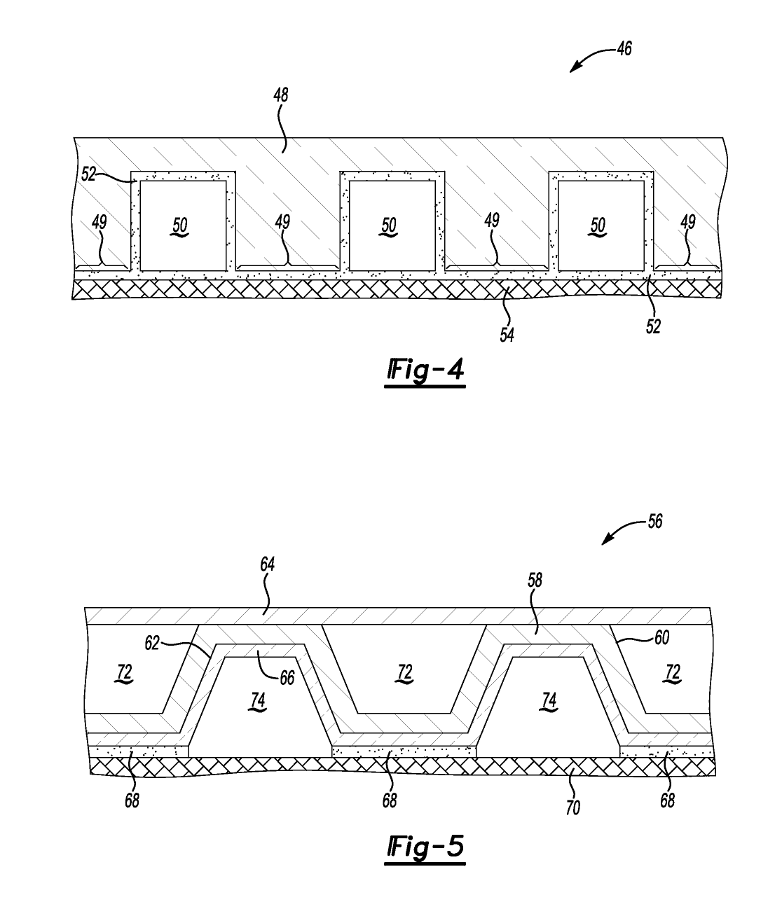

Referring now to FIG. 4, another embodiment of a fuel cell 46 includes a porous plate 48 having landing areas 49 and channels 50 formed therein, a catalyst layer 52 deposited on the landing areas 49 and within the channels 50, and a proton exchange membrane 54 in contact with the catalyst layer 52. In another embodiment, some/all of the channels 50 may be formed completely within the plate 48. That is, for a channel having a rectangular cross-section, all four walls of the channel may be defined by a surface of the plate 48. Other configurations are also possible.

In other embodiments, only portions of the channels 50 may have the catalyst layer 52 deposited thereon. Additionally, portions of the catalyst layer 52 (e.g., the catalyst layer 52 deposited within the channels 50) may include an ionomer to facilitate the transport of protons to and from the membrane 54.

Referring now to FIG. 5, yet another embodiment of a fuel cell 56 includes a corrugated, non-porous plate 58 having opposing surfaces 60, 62, a contact plate 64 in contact with portions of the surface 60, a porous matrix/coating 66 (e.g., graphite, porous carbon, porous metal, conductive plastic, etc.) deposited on the surface 62, a catalyst layer 68 in contact with portions of the porous coating 66, and a proton exchange membrane 70 in contact with the catalyst layer 68.

Portions of the surface 60 and plate 64 define channels 72 configured to direct coolant through the fuel cell 56. Portions of the porous coating 66 and membrane 70 define channels 74 configured to direct gas through the fuel cell 56. The gas may convect (and diffuse) through the porous coating 66 to the catalyst layer 68.

The porous coating 66 in the embodiment of FIG. 5 has a thickness of 120 μm. Of course, the porous coating 66 may have any suitable thickness (e.g., a thickness ranging from 10 μm to 2 mm, etc.). The porosity of the porous coating 66 may range from 0.01 to 0.99. The tortuosity of the porous coating 66 may be at least 1. Optimum coating thickness, porosity, and tortuosity for a given fuel cell design may be determined based on testing, simulation, etc.

In other embodiments, different coatings may be applied to different portions of the surface 62. As an example, a coating having a relatively low porosity may be applied to those portions of the surface 62 that are adjacent to the catalyst layer 68 (i.e., the landing areas), while a coating having a relatively high porosity may be applied to those portions of the surface 62 that define the channels 74. This configuration may improve current collection at the landing areas. Other configurations are also possible. For example, the porous coating 66 may be applied to only certain portions of the surface 62 (e.g., those portions adjacent to the catalyst layer 68).

### Experimental Analysis

Anode-side portions of fuel cells were assembled from commercially available, serpentine flow fields with 5 cm² active areas, 12-W series gas diffusion electrodes with 5 g Pt/m², and Nafion 117 membranes.

Cathode-side portions of fuel cells were of two varieties: conventional non-porous plates with conventional gas diffusion and catalyst layers, and porous graphite plates with catalyst layers supported directly on landing areas of the graphite plates. The graphite plates had dimensions of 1.9″×1.9″×⅜″, with 61% total porosity and 95% open porosity. The serpentine flow fields of the anode-side plates were replicated and machined into the cathode-side plates.

A catalyst ink with a combination of 150 mg, 40% Pt/C and 1200 mg, 5% Nafion solution was prepared and sonicated to ensure better dispersion. The ink was applied to the porous plates by either brushing/spraying the ink on the landing areas or dipping the plates into the ink container. The ink on the porous plates was left to dry under a hood for 24 hours.

The fuel cells were assembled and pre-conditioned by running them for 24 hours subject to 70° C. at 0.2 V with 1000 sccm air/300 sccm hydrogen with 100% RH.

The effective current collector area of porous plates is significantly less than the current collector area for conventional non-porous plates. To account for this difference, active areas were normalized with plate porosity.

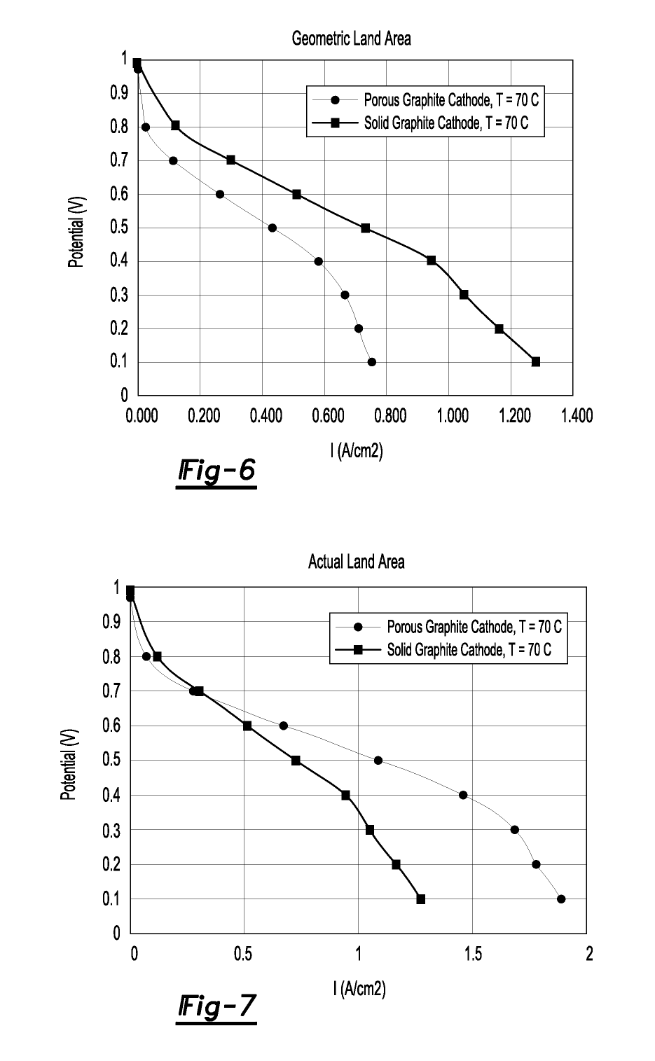

Referring now to FIG. 6, example polarization curves, based on geometric land area, are plotted for (i) fuel cells having cathode-side porous graphite plates lacking gas diffusion layers and (ii) fuel cells having cathode-side conventional non-porous plates with gas diffusion layers. The fuel cells with cathode-side porous plates lacking gas diffusion layers did not include an impermeable cover, such as the cover 44 illustrated with reference to FIG. 3. As such, better performance would be expected in circumstances where such a cover is provided.

Referring now to FIG. 7, example polarization curves, based on actual land area, are plotted for the fuel cells of FIG. 6. The fuel cells with cathode-side porous plates lacking gas diffusion layers appear to demonstrate superior performance compared with the fuel cells with cathode-side conventional non-porous plates with gas diffusion layers.

While embodiments of the invention have been illustrated and described, it is not intended that these embodiments illustrate and describe all possible forms of the invention. The words used in the specification are words of description rather than limitation, and it is understood that various changes may be made without departing from the spirit and scope of the invention.

What is claimed:

1. A fuel cell comprising:
a plate having a flow field formed therein, wherein the flow field is configured to distribute gas throughout the plate;
a catalyst layer in contact with the plate, wherein the plate is configured to permit the gas to at least one of convect and diffuse from the flow field, through the plate, and to the catalyst layer; and
a proton exchange membrane in contact with the catalyst layer.

2. The fuel cell of claim 1 wherein the flow field includes a plurality of channels and wherein the plate is further configured to permit the gas to at least one of convect and diffuse between the channels.

3. The fuel cell of claim 2 wherein at least a portion of the catalyst layer is within the channels of the flow field.

4. The fuel cell of claim 2 wherein the plate is further configured to absorb water droplets within the channels.

5. The fuel cell of claim 1 wherein the plate includes a plurality of landing areas, wherein the catalyst layer is in contact with the landing areas, and wherein a porosity of the plate in a vicinity of the landing areas is less than a porosity of the plate away from the landing areas.

6. The fuel cell of claim 1 wherein the plate has a porosity in the range of 0.01 to 0.99.

7. The fuel cell of claim 1 wherein the plate is comprised of at least one of graphite, porous carbon, and porous metal.

8. A fuel cell comprising:
a plate at least partially defining a flow field configured to distribute gas throughout the plate;
a porous matrix deposited on the plate;
a catalyst layer in contact with the porous matrix, wherein the porous matrix is configured to permit the gas to convect from the flow field, through the porous matrix, and to the catalyst layer; and
a proton exchange membrane in contact with the catalyst layer.

9. The fuel cell of claim 8 wherein the porous matrix comprises at least one of graphite, porous carbon, and porous metal.

10. The fuel cell of claim 8 wherein the porous matrix has a thickness in the range of 10 μm to 2 mm.

11. The fuel cell of claim 8 wherein the porous matrix has a porosity in the range of 0.01 to 0.99.

12. The fuel cell of claim 8 wherein the plate is corrugated.

13. The fuel cell of claim 8 wherein the plate is non-porous.

14. The fuel cell of claim 8 wherein the plate has a plurality of landing areas and wherein the porous matrix is deposited on the landing areas.

15. The fuel cell of claim 14 wherein the porosity of the porous matrix deposited on the landing areas is less than the porosity of the porous matrix deposited elsewhere on the plate.

16. A fuel cell comprising:
a plate system including a porous media having a surface that defines a plurality of channels configured to distribute gas throughout the plate system; and
a catalyst layer in contact with the porous media, wherein the porous media is configured to permit the gas to move from the channels, through the porous media, and to the catalyst layer.

17. The fuel cell of claim 16 wherein the plate system includes a plate and the porous media is deposited on the plate.

18. The fuel cell of claim 16 wherein the plate system includes a plate comprised of the porous media.

19. The fuel cell of claim 16 wherein the porous media comprises at least one of graphite, porous carbon, and porous metal.

20. The fuel cell of claim 16 further comprising a proton exchange membrane in contact with the catalyst layer.
